(19) United States
(12) Patent Application Publication
(10) Pub. No.: US 2014/0077049 A1
(43) Pub. Date: Mar. 20, 2014

(54) Portable and Adjustable Display Support Arm

(71) Applicant: Walsh Gregory Brandon, Syracuse, UT (US)

(72) Inventor: Walsh Gregory Brandon, Syracuse, UT (US)

(21) Appl. No.: 13/784,804

(22) Filed: Mar. 4, 2013

Related U.S. Application Data
(60) Provisional application No. 61/606,994, filed on Mar. 6, 2012.

(51) Int. Cl. F16M 13/02

(52) U.S. Cl. CPC F16M 13/022
USPC 248/288.11; 248/274.1; 248/298.1

(57) ABSTRACT

An adjustable support arm supports a suspended work piece. The adjustable support arm includes a locking hinge mechanism, a sliding member, and sling suspension assembly for supporting a work piece. The adjustable support arm can be secured by placing it between a wall and various objects, furniture, or any suitable items for non-permanent placement of the system. A work piece can be suspended from the sling suspension assembly where a user can easily engage with the work piece. The adjustable support arm includes various mechanisms to allow the user to adjust the position of the work piece to optimize the position and orientation of the work piece.

### FIELD OF INVENTION

The present invention relates generally to support arms, and more particularly, to portable and adjustable display support arms for supporting a work piece such as tablet computers and the like.

### BACKGROUND

Typically, computer devices such as desktop and laptop computers are used by users in a sitting position while the computer devices are placed on desks, tables, or some supportive surfaces. Present day computer devices are typically smaller, lighter, and more portable than the previous generations of computer devices. Accordingly, present day computer devices may be used in many more variety of manners, and a user is not necessarily tied to using a computer device on a desk while sitting in a chair.

### SUMMARY

To take advantage of the present day computer devices that are typically smaller, lighter, and more portable than the previous generations of computer devices, embodiments of the present invention are directed to portable and adjustable display support arms for securing and suspending a work piece (e.g., a computer display monitor, a computer tablet, an art canvas, or any work piece that requires support), so as to provide alternatives to placing a work piece on a tabletop, desktop, or any type of support structure or surface.

Other and further features and advantages of embodiments of the present invention will become apparent from the following detailed description, when read in view of the accompanying figures.

### BRIEF DESCRIPTION OF THE DRAWINGS

The present invention will be readily understood by the following detailed description, taken in conjunction with accompanying drawings, illustrating by way of examples the principles of the invention. The objects and elements in the drawings are not necessarily drawn to scale, proportion, precise orientation or positional relationships; instead, emphasis is focused on illustrating the principles of the invention. The drawings illustrate the design and utility of various embodiments of the present invention, in which like elements are referred to by like reference symbols or numerals. The drawings, however, depict the embodiments of the invention, and should not be taken as limiting the scope of the invention. With this understanding, the embodiments of the invention will be described and explained with specificity and detail through the use of the accompanying drawings in which:

FIG. 1 illustrates one example of a portable and adjustable display support arm in accordance with one embodiment.

FIG. 2 illustrates additional details of one example of a portable and adjustable display support arm in accordance with one embodiment.

FIG. 3 illustrates one example of a hanger assembly for securing and suspending a work piece in accordance with one embodiment.

FIGS. 4A-4B illustrate the details of a portable and adjustable display support arm in accordance with one embodiment.

FIG. 5 illustrates the details of a portable and adjustable display support arm in accordance with one embodiment.

FIG. 6 illustrates additional elements of a portable and adjustable display support arm in accordance with one embodiment.

FIG. 7 illustrates a cantilever arm member of a portable and adjustable display support arm in accordance with one embodiment.

FIGS. 8A-8C illustrate one method of implementing and deploying the portable and adjustable display support arm in accordance with one embodiment.

FIG. 9 illustrates another method of implementing and deploying the portable and adjustable display support arm in accordance with one embodiment.

FIGS. 10A-10B illustrate an additional stabilizer element to provide additional support to the support member of the portable and adjustable display support arm in accordance with one embodiment.

FIGS. 11A-11B illustrate another stabilizer element to provide greater support to the support member of the portable and adjustable display support arm in accordance with one embodiment.

### DETAILED DESCRIPTION OF ILLUSTRATED EMBODIMENTS

Reference will now be made in detail to the preferred embodiments of the present invention, examples of which are illustrated in the accompanying drawings. While the invention will be described in conjunction with the preferred embodiments, it will be understood that they are not intended to limit the scope of the invention to these embodiments. On the contrary, the invention is intended to cover alternatives, modifications, and equivalents that may be included within the spirit and scope of the invention. Furthermore, in the following detailed description of the present invention, numerous specific details are set forth in to order to provide a thorough understanding of the present invention. However, it will be readily apparent to one of ordinary skilled in the art that the present invention may be practiced without these specific details.

A portable and adjustable display support arm in accordance with the present invention is particularly useful in the present day environment where portable computers have become pervasive in all aspects of modern day life. The portable and adjustable display support arm provides an alternative to the traditional way of working or engaging with a computing device or a work piece that may be typically placed on a tabletop or desktop.

A portable and adjustable display support arm in accordance with the invention does not require fixed mounting or support in order to be operable. Instead, it only requires to be properly supported. There are numerous ways to properly support the portable and adjustable display support arm. In one implementation, it can be placed between two supporting structures or objects for support. For example, a section of the portable and adjustable display support arm can be placed between a wall and a headboard of a bed, a back of a nightstand, a back of a couch, or any other furniture or object that may provide some resistance to movement. In another implementation, it can be secured by a suitable structure or object (e.g., a headboard of a bed) without being placed between two supporting structures or objects. In another embodiment, the portable and adjustable display support arm can be fixedly secured to a structure (e.g., a wall) or an object. The flexibility of the portable and adjustable display support arm allows many ways for it to be secured and deployed.

As with the recent growth in the popularity of tablet computers, it now very common to be using a tablet computer while lying on a couch or in bed. It would be useful to use the portable and adjustable display support arm in accordance with the present invention to secure and support a tablet computer, such that a user can avoid becoming fatigued with holding the tablet computer while using the tablet computer in bed or lying on a couch. This would be particularly useful if the user has some physical limitations and working in bed may be more suitable than sitting on a chair in front of a table.

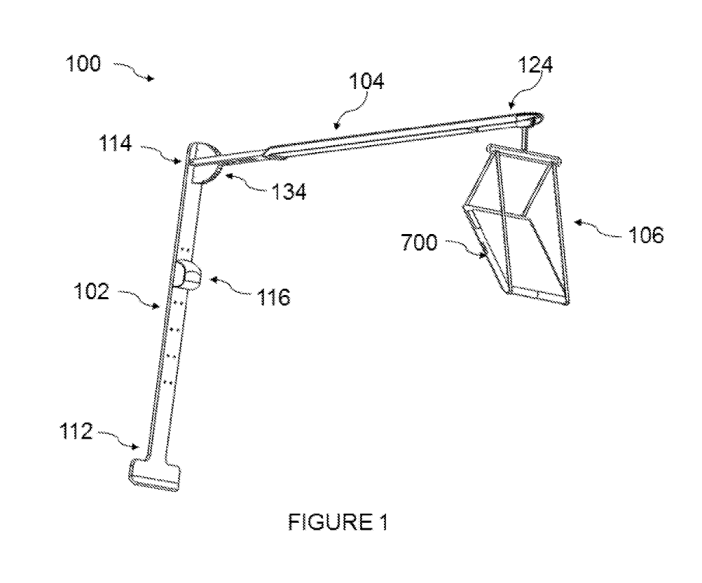

As illustrated in FIG. 1, an embodiment of the portable and adjustable display support arm assembly (100) in accordance with embodiments of the present invention comprises of a support member (102) having first (112) and second (114) ends and a cantilever arm member (104), wherein the cantilever arm member (104) is coupled to the support member (102) at the second end (114) of the support member (102). The portable and adjustable display support arm assembly (100) further includes a hanger assembly (106) for securing a work piece (700) (e.g., computer tablet). As illustrated in FIG. 1, the hanger assembly (106) allows the work piece (700) be oriented or angled in a suitable position for proper engagement with a user. The hanger assembly (106) is coupled to a distal portion (124) of the cantilever arm member (104). The support member (102) may further include a support element (116), wherein the support element (116) is disposed between the first (112) and second (114) ends of the support member (102). The support element (116) may be used as a contact point to one of the structures or objects that is used to support or secure the support member (102) in a substantially fixed position. In some embodiments, the position of the support element may be fixed. In some another embodiments, the position of the support element (116) may be adjustable. For example, the position of the support element (116) may be able to be adjusted up or down along the length of the support member (102) so that support element (116) can be properly positioned to engage or contact with one of the structures or objects that is used to support or secure the support member (102). Furthermore, the support element (116) may be made of or formed from a substantially soft, ductile, or soft-grip material so that it has the inherent ability to allow its engaging surface to deform or adopt to the shape of the engaging surface of the support structure or object (e.g., a headboard of a bed, a back of a nightstand, a back of a couch, or any other furniture or object that may provide some resistance to movement) to allow for a more secured engagement with the support structure or object. In some embodiments, an engagement surface of the support element (116) may be contoured to allow for an even more secured engagement with the support object.

In some embodiments, the support member (102) may be fixedly coupled to cantilever arm member (104). In some other embodiments, the support member (102) may be movably coupled to the cantilever arm member (104). For example, the support member (102) may be coupled to the cantilever arm member (104) by way of a joint element (134). The joint element (134) may allow the cantilever arm member (104) one or more degrees of movements (e.g., rotational movement in a substantially vertical plane, rotational movement in a substantially horizontal plane, etc.) relative to the support member (102).

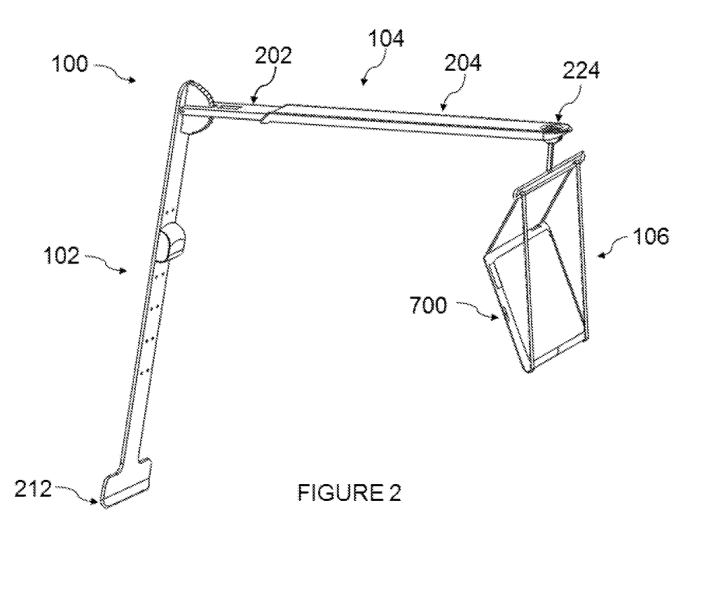

As illustrated in FIG. 2, the support member (102) may include a soft grip element (212) to allow for a more secured engagement with various support structures or objects for securing the support member (102), which in turn increases the stability of the portable and adjustable display support arm assembly (100) when deployed. For example, when the support member (102) is secured between a wall and a headboard of a bed, the soft grip element (212) can provide a more secured engagement with the wall, such that support member (102) may be more stably secured between the wall and headboard of the bed. Also illustrated in FIG. 2, the cantilever arm member (104) may include a rail member (202) and a sleeve member (204), in which the sleeve member (204) may be operated telescopically over the rail member (202) such that the length of the cantilever arm member (104) may be adjusted as desired by a user. Furthermore, the cantilever arm member (104) may include a swivel joint (224) for coupling with the hanger assembly (106). The swivel joint (224) allows the hanger assembly (106) at least one degree of movement, such as swivel or rotate about an axis.

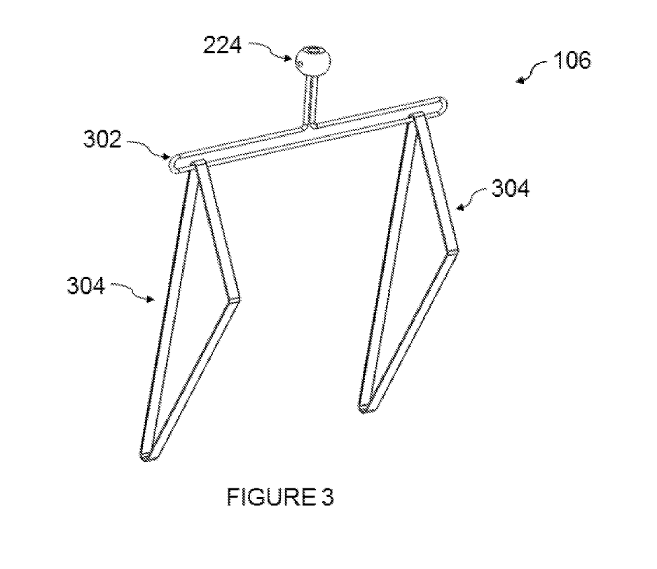

FIG. 3 illustrates the hanger assembly (106) in greater detail. As illustrated, the hanger assembly (106) may be coupled to the swivel joint (224). The swivel joint (224) may be a ball joint (as illustrated), a u-joint (not shown), or any type of rotational-type of joint that allows for at least one-degree of freedom of rotation (e.g., about 0 to about 180 degrees of rotation in at one axis of rotation). The hanger assembly (106) may include a hanger element (302) and secure elements (304) for securing the work piece (700) (not shown in this figure). The work piece (700) is secured by the hanger assembly (106). The position of the work piece (700) can be adjusted by moving the sleeve member (204) along the rail member (202) such that the length of the cantilever arm member (104) can be made longer or shorter for positioning the work piece (700) as desired. In addition, the orientation or angle of the work piece can also be adjusted by operating the swivel joint (224) such that a user can optimize the orientation of the work piece for optimum engagement or user experience with the work piece. Furthermore, the pitch of the work piece (700) may be adjusted by adjusting the position or pitch of the work piece in the secure elements (304). As can be appreciated, embodiments of the portable and adjustable display support arm (100) in accordance with the present invention provide many points of adjustments to suitably position a work piece for optimum engagement with a user.

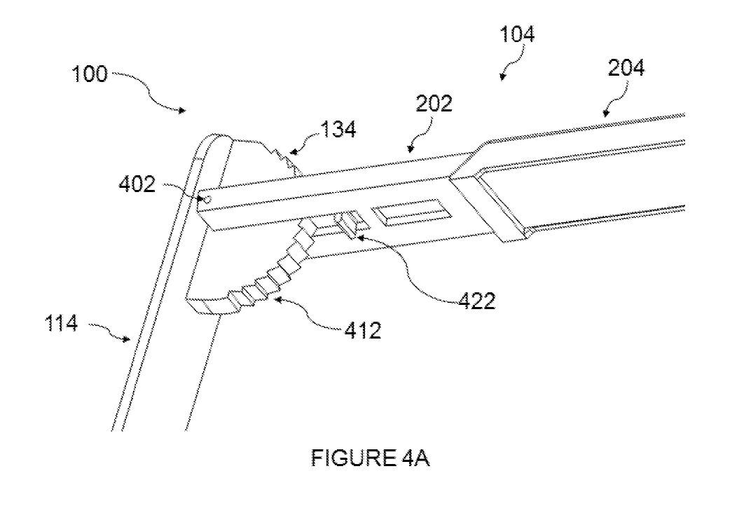

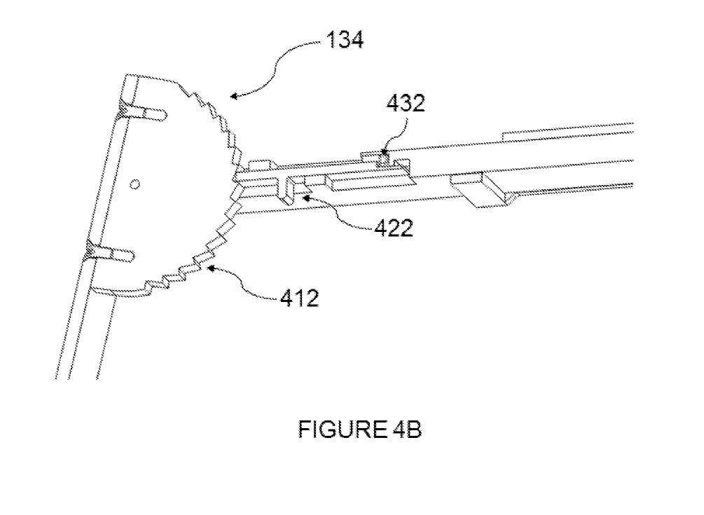

FIG. 4A illustrates one example of the joint element (134) of the adjustable display support arm assembly (100). The rail member (202) may include a lock and release mechanism (422) that engages or disengages with gears (412) of the joint element (134), such that orientation or angle of the cantilever arm member (104) may be adjusted. For example, the orientation of the cantilever arm member (104) may be rotated angularly about a center axis of a pin (403) of the joint element (134). FIG. 4B illustrates a sectional view of a portion of the support arm assembly. In this example, the lock and release mechanism (422) may include a spring element (432) that activates the locking operation of the lock and release mechanism (422).

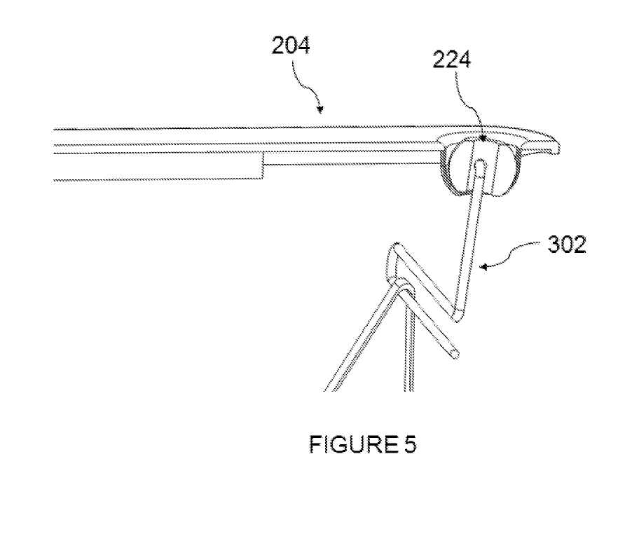

FIG. 5 illustrates a sectional view of the sleeve member (204) with the swivel element (224). In this example, the swivel element (224) is a ball-socket joint. In other embodiments, the swivel element (224) may be a U-joint or any other type of joint that would allow one or more degrees of freedom of rotation.

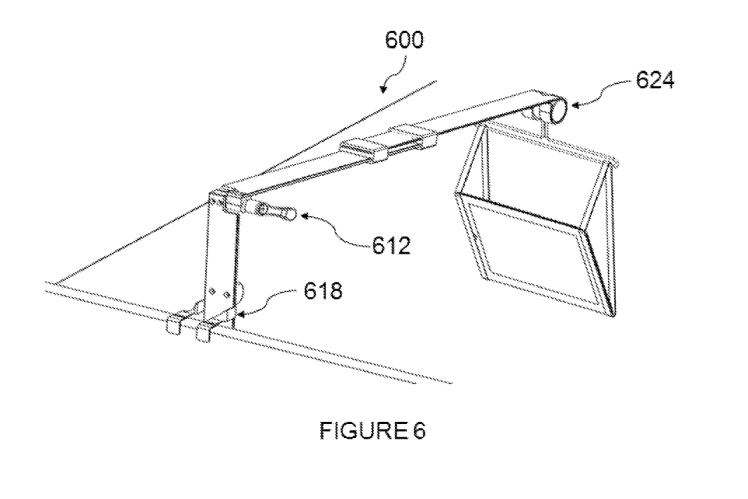

FIG. 6 illustrates another embodiment of the portable and adjustable display support arm (600). The portable and adjustable display support arm includes a lasso element (618) which secures the support arm to an object. In this example, lasso element (618) secures the support member of the display support arm (600) to a headboard of a bed, such that the display support arm does not need to be secured or supported by two objects. The support member is coupled to the cantilever arm member by way of a joint element (612). In this example, the joint element (612) includes a handle that adjusts the angle or pitch of the cantilever arm member. The hanger assembly is coupled to the cantilever arm through a swivel element (624).

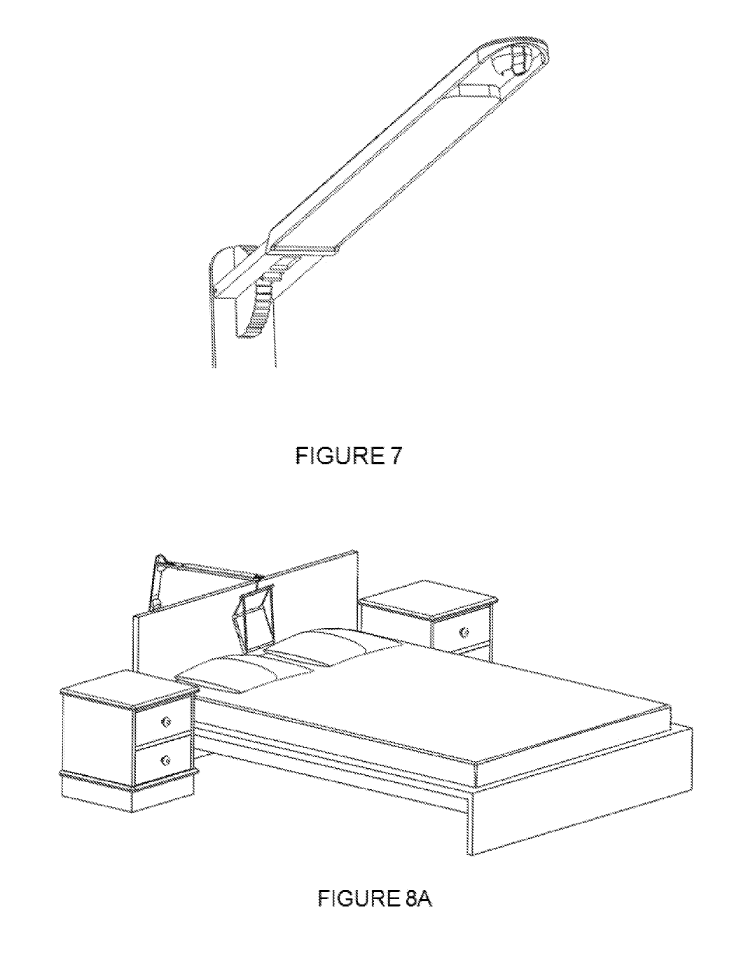

FIG. 7 illustrates one view of the cantilever arm of the portable and adjustable display support arm.

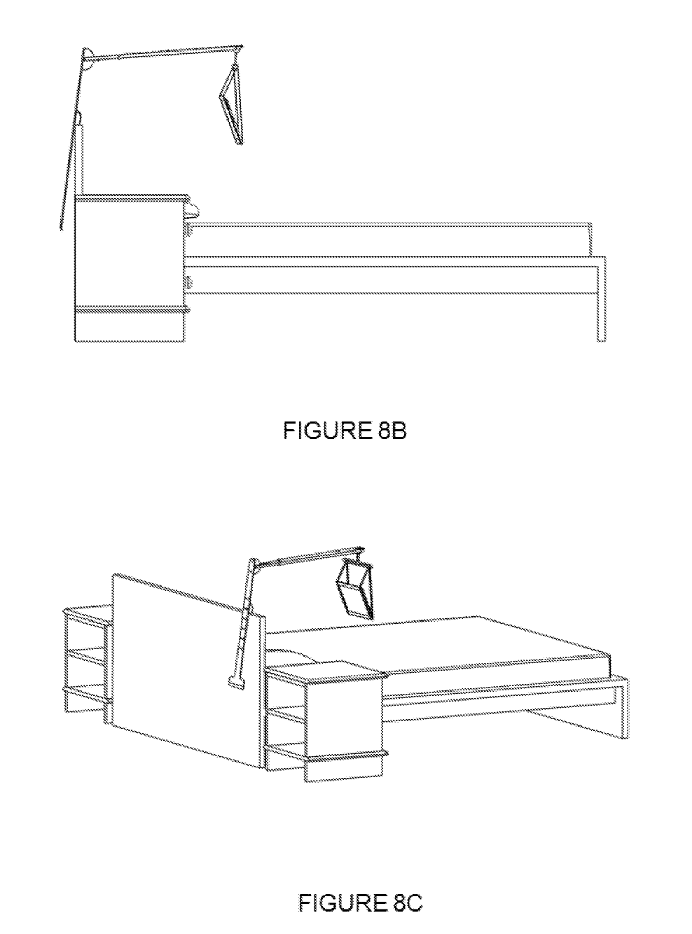

FIGS. 8A-8C illustrates an example of how the portable and adjustable display support arm may be secured and deployed. In this example, the portable and adjustable display support arm is secured by placing it between a wall and headboard of a bed, and it is deployed over the bed. A work piece, such as a tablet computer, may be suspended from the hanger assembly of the support arm while a user is lying in bed. The user can engage with the work piece while the work piece is suspended and positioned in a most optimum position and orientation desired by the user. The user does not have to support the work piece, thus avoiding fatigue or strain caused by holding the work piece.

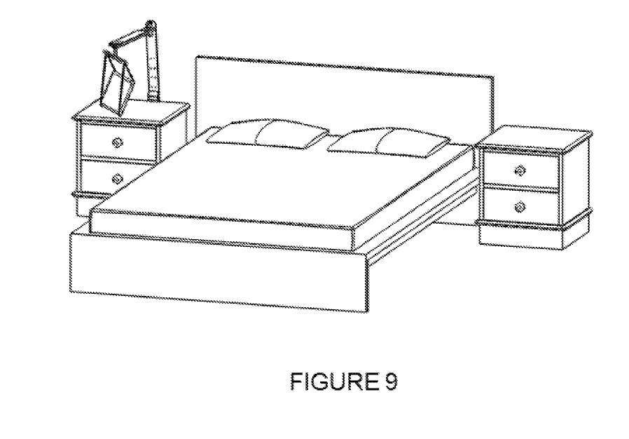

FIG. 9 illustrates an example of how the portable and adjustable display support arm may be secured between a wall and a nightstand next to a bed.

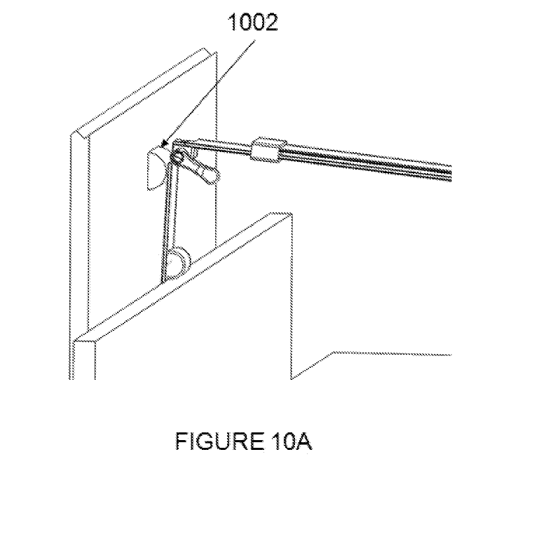

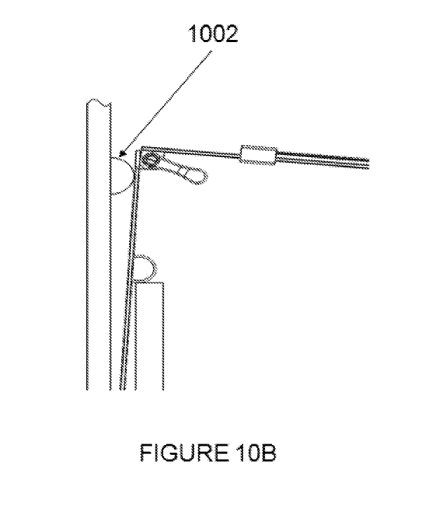

FIGS. 10A-10B illustrates an additional stabilizer element (1002) that may be operably coupled to the support member of the portable and adjustable display support arm. The stabilizer element (1002) may act as a counter-balancing support element for the support member as the display support arm is secured between two objects (such as a wall and a headboard of a bed). The stabilizer element (1002) may provide a counter-acting force to further stabilizer or secured the display support arm between two objects.

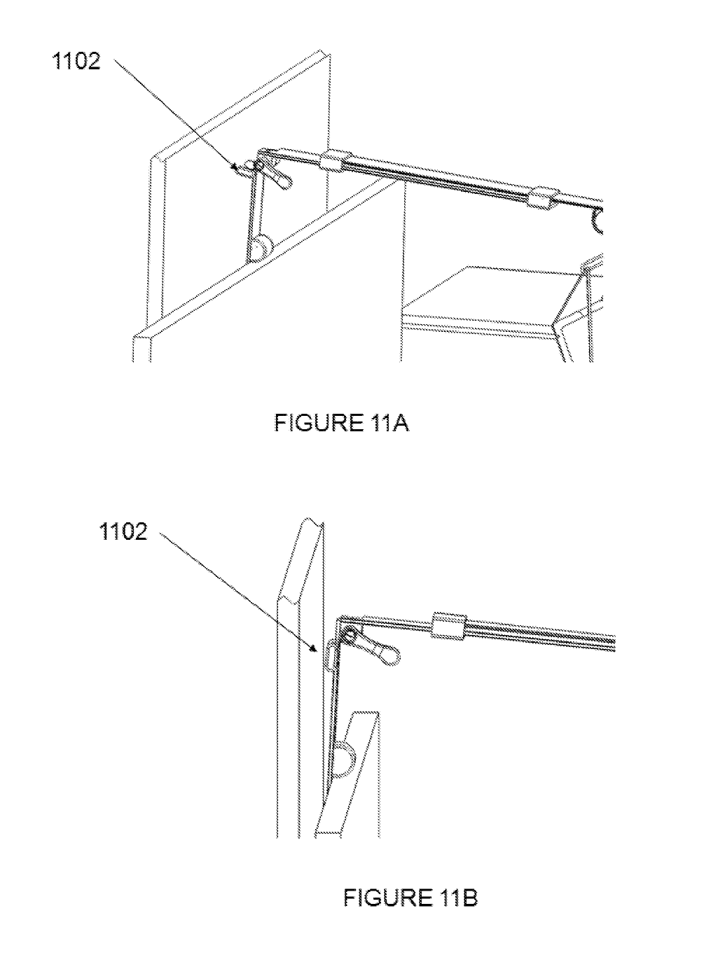

FIGS. 11A-11B illustrates another stabilizer element (1102) that may be operably coupled to the support member of the portable and adjustable display support arm. In this example, as illustrated in FIG. 11A, the stabilizer element (1102) is folded-out or extended to provide greater counter-balancing support for the support member as the display support arm is secured between two objects (such as a wall and a headboard of a bed). In a folded-out or extended configuration, the stabilizer element (1102) may provide a greater counter-acting force to further stabilizer or secured the display support arm between two objects. FIG. 11B illustrates the stabilizer element (1102) in a folded-down or non-extended configuration. In this folded-down or non-extended position, the stabilizer element (1102) still provides substantial counter-balancing support for support member to fully secure and support the portable and adjustable display support arm.

Multiple embodiments and variations of the various aspects of the invention have been disclosed and described herein. Many combinations and permutations of the disclosed system may be useful in securing and positioning a work piece for optimum engagement with a user. One of ordinary skill in the art having the benefit of this disclosure would appreciate that the foregoing illustrated and described embodiments of the invention may be modified or altered, and it should be understood that the invention generally, as well as the specific embodiments described herein, are not limited to the particular forms or methods disclosed, but also cover all modifications, equivalents and alternatives. Further, the various features and aspects of the illustrated embodiments may be incorporated into other embodiments, even if not so described herein, as will be apparent to those ordinary skilled in the art having the benefit of this disclosure. Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as described by the description, drawings, and claims.

What is claimed is:

1. An adjustable support arm assembly, comprising:
a support member having first and second ends;
a cantilever arm member coupled to the support member, wherein a proximal end of the cantilever arm member is coupled to the second end of the support member;
a hanger assembly coupled to a distal end of the cantilever arm member, wherein the hanger assembly is configured to secure and suspend a work piece at the distal end of the cantilever arm member.

2. The adjustable support arm assembly of claim 1, further comprising:
a joint element coupling the cantilever arm member to the support member, wherein the joint member allows the cantilever arm member to be rotated angularly.

3. The adjustable support arm assembly of claim 1 wherein the cantilever arm member can be operated telescopically, such that the cantilever arm can be extended from a first length to a second length.

4. The adjustable support arm assembly of claim 1 further comprising:
a swivel element couple the hanger assembly to the cantilever arm member, wherein the swivel element allows the hanger assembly to be rotated.
